(19) United States
(12) Patent Application Publication
(10) Pub. No.: US 2011/0283358 A1
(43) Pub. Date: Nov. 17, 2011

(54) METHOD AND SYSTEM TO DETECT MALWARE THAT REMOVES ANTI-VIRUS FILE SYSTEM FILTER DRIVER FROM A DEVICE STACK

(75) Inventors: Cedric Cochin, Portland, OR (US); Rachit Mathur, Hillsboro, OR (US); Tracy E. Camp, Beaverton, OR (US)

(73) Assignee: MCAFEE, INC., Santa Clara, CA (US)

(21) Appl. No.: 12/781,263

(22) Filed: May 17, 2010

(51) Int. Cl. G06F 21/00; G06F 11/00

(52) U.S. Cl. 726/23

(57) ABSTRACT

A method for detecting removal of a filter driver includes performing an operation on an element of a kernel mode of an operating system, the operation initiated by a user mode entity, obtaining the result of performing the operation, and comparing the result of performing the operation against an expected result of the operation. If the result of performing the operation matches the expected result of the operation, it is determined that a file system filter driver in the kernel mode of the operating system is working correctly. If the result of performing the operation does not match the expected result of the operation, it is determined that a file system filter driver in the kernel mode of the operating system has been compromised by malware.

### TECHNICAL FIELD OF THE INVENTION

The present invention relates generally to computer security and malware protection and, more particularly, to a method and system to detect malware that removes anti-virus file system filter driver from a device stack.

### BACKGROUND

Malware infections on computers and other electronic devices are very intrusive and hard to detect and repair. Even more difficult to detect and repair are malware infections that defeat anti-malware systems, software, devices, processes, and services themselves. For example, an antivirus file system filter driver may be implemented in a device stack of an operating system of an electronic device to protect against malware that would send malicious operations affecting the file system of the electronic device. However, malware may remove, hack, spoof, misdirect, or otherwise compromise the operation of the antivirus file system filter driver itself. The same malware may prevent the ability to scan for the presence of the antivirus file system driver.

Malware may include, but is not limited to, spyware, rootkits, password stealers, spam, sources of phishing attacks, sources of denial-of-service-attacks, viruses, loggers, Trojans, adware, or any other digital content that produces unwanted activity.

### SUMMARY

A method for detecting removal of a filter driver includes performing an operation on an element of a kernel mode of an operating system, the operation initiated by a user mode entity, obtaining the result of performing the operation, and comparing the result of performing the operation against an expected result of the operation. If the result of performing the operation matches the expected result of the operation, it is determined that a file system filter driver in the kernel mode of the operating system is working correctly. If the result of performing the operation does not match the expected result of the operation, it is determined that a file system filter driver in the kernel mode of the operating system has been compromised by malware.

In a further embodiment, an article of manufacture includes a computer readable medium and computer-executable instructions. The computer-executable instructions are carried on the computer readable medium. The instructions are readable by a processor. The instructions, when read and executed, cause the processor to perform an operation on an element of a kernel mode of an operating system, the operation initiated by a user mode entity, obtain the result of performing the operation, and compare the result of performing the operation against an expected result of the operation. If the result of performing the operation matches the expected result of the operation, the processor is caused to determine that a file system filter driver in the kernel mode of the operating system is working correctly. If the result of performing the operation does not match the expected result of the operation, the processor is caused to determine that a file system filter driver in the kernel mode of the operating system has been compromised by malware.

In yet another embodiment, a system for detecting malware includes a processor, a computer readable medium, and computer-executable instructions carried on the computer readable medium. The instructions, when read and executed, cause the processor to perform an operation on an element of a kernel mode of an operating system, the operation initiated by a user mode entity, obtain the result of performing the operation, and compare the result of performing the operation against an expected result of the operation. If the result of performing the operation matches the expected result of the operation, the processor is caused to determine that a file system filter driver in the kernel mode of the operating system is working correctly. If the result of performing the operation does not match the expected result of the operation, the processor is caused to determine that a file system filter driver in the kernel mode of the operating system has been compromised by malware.

### BRIEF DESCRIPTION OF THE DRAWINGS

For a more complete understanding of the present invention and its features and advantages, reference is now made to the following description, taken in conjunction with the accompanying drawings, in which:

FIG. 1 is an illustration of an example system for detecting malware that remove antivirus file system filter drivers from a device stack;

FIG. 2 is more detailed view of the operation of an electronic device on which malware that remove antivirus file system filter drivers from a device stack may be detected; and

FIG. 3 is an example embodiment of a method to detect malware that remove antivirus file system filter drivers from a device stack.

### DETAILED DESCRIPTION

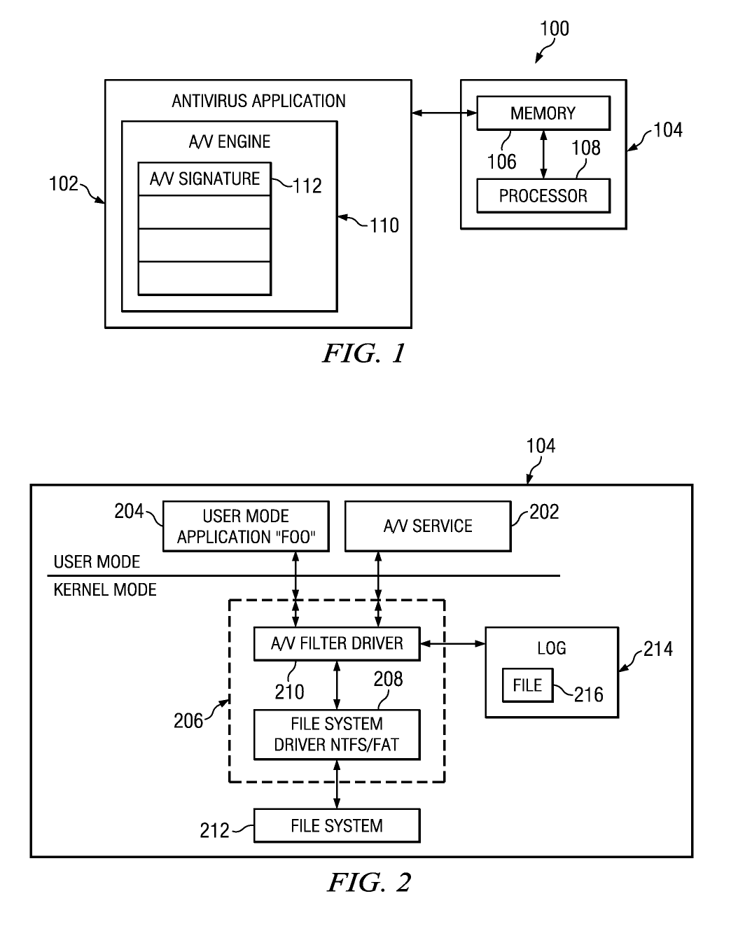

FIG. 1 is an illustration of an example system 100 for detecting malware that remove antivirus file system filter drivers from a device stack. System 100 may comprise an antivirus application 102 and an electronic device 104. Antivirus application 102 may be configured to scan electronic device 104 for evidence of malware or removal of file system filter drivers from a device stack. For example, antivirus application 102 may be configured to evaluate whether a file system filter driver has been removed, altered, or otherwise tampered with, and subsequently fix, repair, inoculate, or reinstall a file system filter driver. A file system filter driver may comprise an application, process, executable, object code, or any other entity suitable to intercept and inspect requests to the file system or file system driver of an electronic device. A file system filter driver may be a portion of an antivirus scheme, wherein file operation requests from applications, processes, executables, scripts, or similar entities on an electronic device are filtered to determine whether the request constitutes suspicious activity indicative of malware. The file system filter driver may be configured to take corrective action based upon the request. The file system filter driver may be resident within the kernel mode of the operating system of the electronic device.

In one embodiment, antivirus application 102 may be configured to operate in a cloud computing scheme. Antivirus application 102 may comprise software that resides on a network, and may be loaded and executed on a machine on the network. In such an embodiment, antivirus application 102 may be communicatively coupled to electronic device 104 through the network. Antivirus application 102 may scan electronic device 104 without executing on electronic device 104.

In one embodiment, antivirus application 102 may reside on electronic device 104. Antivirus application 102 may be loaded and executed on electronic device 104. In another embodiment, portions of antivirus application 102 may reside on electronic device 104, and other portions of antivirus application 102 may reside on another machine communicatively coupled to electronic device 104.

Electronic device 104 may comprise any device configurable to interpret and/or execute program instructions and/or process data, including but not limited to: a computer, desktop, server, laptop, personal data assistant, or smartphone. Electronic device 104 may comprise a processor 108 coupled to a memory 106. Electronic device 104 may comprise a memory 106 coupled to a processor 108.

Processor 108 may comprise, for example a microprocessor, microcontroller, digital signal processor (DSP), application specific integrated circuit (ASIC), or any other digital or analog circuitry configured to interpret and/or execute program instructions and/or process data. In some embodiments, processor 108 may interpret and/or execute program instructions and/or process data stored in memory 106. Memory 106 may be configured in part or whole as application memory, system memory, or both. Memory 106 may include any system, device, or apparatus configured to hold and/or house one or more memory modules. Each memory module may include any system, device or apparatus configured to retain program instructions and/or data for a period of time (e.g., computer-readable media).

Antivirus application 102 may comprise any application, process, script, module, executable, server, executable object, library, or other suitable digital entity. Antivirus application 102 may be configured to reside in memory 106 for execution by processor 108 with instructions contained in memory 106. Antivirus application 102 may comprise an antivirus engine 110, operable to provide logic, rules, scripts, and/or instructions to antivirus application 102 to detect malware. Antivirus engine 110 may comprise any application, process, script, module, executable, server, executable object, library, or other suitable digital entity. Antivirus engine 100 may comprise one or more antivirus signatures 112, each signature comprising a set of logic, rules, scripts, and/or instructions for detecting malware in a particular way.

Antivirus application 102 may be configured to examine portions of memory 106 in order to detect malware that remove antivirus file system filter drivers from a device stack. In one embodiment, antivirus application 102 may examine portions of memory 106 comprising an operating system.

FIG. 2 is more detailed view of the operation of an electronic device 104 on which malware that remove antivirus file system filter drivers from a device stack may be detected. FIG. 2 may depict the loading and operation of certain elements of electronic device 104 within the context of the operation of an operating system. Electronic device 104 may comprise one or more applications such as antivirus service 202 or user mode application “FOO” 204 operating in the user mode of the operating system running on electronic device 104, accessing file system 212 through making calls to a device stack 206 operating in the kernel mode of the operating system running on electronic device 104.

Antivirus service 202 may comprise a portion of antivirus application 102. Antivirus service 202 may be implemented in whole or in part in antivirus application 102. Antivirus service 202 may comprise any application, process, script, module, executable, server, executable object, library, or other suitable digital entity. In one embodiment, antivirus service 202 may be operating on a device other than electronic device 104. In another embodiment, antivirus service 202 may be resident in memory 106 and executed by processor 108. Antivirus service 202 may be configured to carry out operations such that antivirus application 102 may detect malware that remove antivirus file system filter drivers from a device stack on electronic device 104. Antivirus service 202 may be configured to attempt to access file system 212 through the calling of device stack 206. Antivirus service 202 may be configured to send read and write commands to device stack 206 in the kernel mode of electronic device 104. Antivirus service 202 may be configured to receive messages from device stack 206 concerning the result of the commands that were sent.

User mode application “FOO” 204 may comprise any application, process, script, module, executable, server, executable object, library, or other suitable digital entity. User mode application “FOO” 204 may be configured to attempt to access file system 212 through the calling of device stack 206. User mode application “FOO” 204 may be configured to send read and write commands to device stack 206 in the kernel mode of electronic device 104. User mode application “FOO” 204 may be configured to receive messages from device stack 206 concerning the result of the commands that were sent.

Device stack 206 may be configured to provide access to elements of electronic device 104 to file system 212. Device stack 206 may comprise any number of interfaces, protocols, drivers, or filters. In one embodiment, device stack 206 may comprise a file system driver 208 and an antivirus filter driver 210. Device stack 206 may be configured to be accessible by user mode elements in electronic device 104 such as user mode application “FOO” 204 and antivirus service 202. Device stack 206 may be configured to access file system 212 and perform operations upon it at the request of other elements of electronic device 104. Device stack 206 may be configured to return data from file system 212, write data to file system 212, or return messages or other information to other elements of electronic device 104.

File system 212 may comprise an organization of elements contained within a memory such as memory 106. File system 212 may be configured to store information that may be written or accessed by device stack 206. File system 212 may comprise any suitable organization of elements within a memory. In one embodiment, file system 212 may be organized as a New Technology File System (“NTFS”) file system. In another embodiment, file system 212 may be organized as a File Allocation Table (“FAT”) file system.

File system driver 208 may be configured to directly access file system 202. File system driver 208 may be provided as part of an operating system for electronic device 104. File system driver 208 may comprise the lowest element of device stack 206. File system driver 208 may be configured to operate specifically with the kind of file system it accesses; for example, if file system 212 comprises an NTFS file system, file system driver 208 may comprise an NTFS file system driver. File system driver 208 may be configured to receive requests from user mode application or from other, higher elements in device stack 206 for accessing file system 212. File system driver 208 may comprise any application, process, script, module, executable, executable object, library, or other suitable digital entity.

Antivirus filter driver 210 may be configured to filter requests received by the device stack 206 before the requests reach file system driver 208. Antivirus filter driver 210 may be configured to perform actions in addition to or in place of actions requested of file system driver 208. For example, antivirus filter driver 210 may intercept read and write requests that would be intended to affect protected memory locations in memory 106. Such requests, if coming from an unexpected process or application in electronic device 104 may comprise a request from malware. Antivirus filter driver 210 may be configured to apply antivirus signatures 112 from antivirus application 102 in determining how to filter requests given to device stack 206.

Antivirus filter driver 210 may be configured to read and write data from log 214. Log 214 may comprise a portion of memory 106 configured to be written to by only certain elements of electronic device 104. In one embodiment, log 214 may be configured to be written to only by antivirus filter driver 210. In another embodiment, log 214 may be implemented in virtual memory. Log 214 may be implemented in any suitable way for writing to protected memory space. Log 214 may comprise a file 216. File 216 may comprise a uniquely identifiable virtual file. File 216 may be configured to be created, written to, copied, read, or otherwise accessed by antivirus filter driver 210.

Antivirus filter driver 210 may be configured to conduct or simulate operations on file 216 or other entities within log 214. For example, antivirus filter driver 210 may configured to allow open and read file 216 based on requests from antivirus service 202. Antivirus filter driver 210 may return to antivirus service the results of the operations. In one embodiment, file 216 may comprise a virtual file, and antivirus filter driver 210 may be configured to interpret access requests from an application such as antivirus service 202 as requests to access file 216 by, for example, use of a unique file name that would be unable to exist on a normal file system such as file system 212. In such an embodiment, because antivirus filter driver 210 may be configured to intercept all file requests to stack 206, antivirus filter driver 210 may be configured to interpret such a file name as specifically intended to reach antivirus filter driver 210, and not intended eventually for file system driver 208. The name of file 216 may be unique and may be known to both antivirus service 202 and antivirus filter driver 210. In one embodiment, the name of file 216 may be unable to exist on file system 212 because the name of file 216 comprises an illegal name. In such an embodiment, the possible values of the name of file 216 may depend upon the operating system or the protocol or format of file system 212. For example, if file system 212 were configured as an NTFS file system, then file names with characters such as those in the set {/ ? < > \ : *} would be illegal, as would be a file name with a length over 256 characters long. Thus, if antivirus filter driver 210 receives a read file request for a file named “foo /.doc” antivirus filter driver may be configured to interpret the request as request to access a uniquely identifiable virtual file, such as file 216. Antivirus filter driver 210 may be configured to perform the requested operation on file 216, and return the result to the requesting application. Conversely, file system driver 208 may be configured to return an error to the requesting application upon receiving an operation request for such a file named “foo /.doc.”

Antivirus service 202 may be configured to apply a verification scheme to stack 206 to determine whether or not antivirus filter driver 210 is present, active, and working correctly in stack 206. Antivirus service 202 may be configured to apply any suitable scheme. Antivirus service 202 may be configured to apply a scheme as defined in antivirus signatures 112. Antivirus service 202 may be configured to access or receive information from antivirus engine 110 or antivirus application 102 in regards to antivirus signatures 112.

In one embodiment, file 216 may comprise a predefined set of information that is known to antivirus service 202. In such an embodiment, antivirus service 202 may obtain such information from antivirus signatures 112. In such an embodiment, antivirus service 202 may, for example, make a read or write request from file 216. Antivirus service 202 may be configured to compare the results of the read or write request from file 216 against expected results. If antivirus filter driver 210 has been compromised, hacked, removed, or otherwise compromised, the results of the read or write request may differ from the expected results. Antivirus service 202 may thus be configured to determine whether or not antivirus filter driver 210 is present, active, and working correctly in stack 206 by whether antivirus filter driver 210 correctly handles an operation request from antivirus service 202 on file 216. For example, in response to a request, such as a read or write request, for file 216, where file 216 comprises an illegal name, stack 206 may return an error, instead of the expected result, if antivirus filter driver 210 has been modified, hacked, removed, or otherwise compromised. In another example, in response to a read request for file 216, stack 206 may return a result that differs from the expected result, if antivirus filter driver 210 has been modified, hacked, removed, or otherwise compromised.

If antivirus filter driver 210 has been modified, hacked, removed, or otherwise compromised, antivirus service 202 may be configured to take corrective action with regards to antivirus filter driver 210. Antivirus service 202 may be configured to notify antivirus engine 112 that antivirus filter driver 210 has been modified, hacked, removed, or otherwise compromised. Antivirus service 202 may be configured to notify antivirus application 102 that antivirus filter driver 210 has been modified, hacked, removed, or otherwise compromised. Antivirus service 202 may be configured to notify a user or administrator of antivirus application 102 or electronic device 104 that antivirus filter driver 210 has been modified, hacked, removed, or otherwise compromised. Antivirus service 202 may be configured to send information to a networked server that antivirus filter driver 210 has been modified, hacked, removed, or otherwise compromised. Such information may include information about values or data contained within stack 206. Such information may also include information about electronic device 104. Antivirus service 202 may be configured to repair antivirus filter driver 210. In one embodiment, antivirus service 202 may be configured to reinstall antivirus filter driver 210. Antivirus service 202 may be configured to take any suitable corrective action to correct the installation of antivirus filter driver 210 that has been modified, hacked, removed, or otherwise compromised.

In one embodiment, antivirus engine 112 may be configured to take some or all of the corrective action described above. In another embodiment, antivirus application 102 may be configured to take some or all of the corrective action described above.

In operation, antivirus application 102 may be operating to monitor or scan electronic device 104 for malware. Antivirus application 102 may be running on electronic device 104 itself, or may be operating on a server communicatively coupled to electronic device 104. Antivirus application 102 may be executed by processor 108 with instructions in memory 106. Antivirus engine 110 may be running within antivirus application 102. Antivirus application 102 or antivirus engine 110 may apply antivirus signatures 112 in determining whether malware is present on electronic device 104. Antivirus service 202 may be running on electronic device 104 itself, or may be operating on a server communicatively coupled to electronic device 104. Antivirus service 202 may be operating as part of or separately from antivirus application 102. Antivirus service 202 may be communicatively coupled to antivirus application 102. Antivirus service 202 may be operating with user mode access to the operating system of electronic device 104.

Antivirus service 202 may make requests to entities in the kernel mode of the operating system of electronic device 104. For example, antivirus service 202 may make read or write requests to stack 206. Antivirus service 202 may receive the results of the requests that it makes to entities in the kernel mode of the operating system of electronic device 104. Antivirus service 202 may determine whether or not antivirus filter driver 210 is resident and functioning correctly within stack 206. In one embodiment, antivirus service 202 may utilize antivirus signatures 112 to determine whether or not antivirus filter driver 210 is resident and functioning correctly within stack 206.

Antivirus filter driver 210 may be resident and operating correctly within stack 206. If resident and operating correctly within stack 206, antivirus filter driver 210 may intercept requests from user mode applications such as antivirus service 202 to file system driver 208. Antivirus filter driver 210 may determine whether such requests constitute requests associated with malware. If such requests are associated with malware, antivirus filter driver 210 may notify antivirus service 202 or another entity, block the requests, or take any other suitable corrective action. If such requests are not associated with malware, antivirus filter driver 210 may pass such requests to file system driver 208, which may in turn conduct operations on file system 212. Results of requests from antivirus service 202 may be sent from file system driver 208 to antivirus filter driver 210, and out from stack 206 to user mode applications such as antivirus service 202. Antivirus filter driver may make read and write requests to log 214 or file 216. Such read and write requests may relate to activities including but not limited to data logging, version verification, or authentication.

Antivirus filter driver 210 may have been removed, spoofed, altered, hacked, or otherwise compromised by malware. In such a case, antivirus filter driver 210 may correctly analyze and report on user mode requests. For example, malware may cause antivirus filter driver 210 to not receive the requests, analyze the requests incorrectly, have its results or corrective actions blocked or misdirected, or have its results or corrective actions spoofed.

Antivirus service 202 may send requests to and receive replies from entities in the kernel mode of the operating system of electronic device 104 to determine whether or not antivirus filter driver 210 is resident and operating correctly within stack 206. In one embodiment, antivirus service 202 may send requests to and receive replies from stack 206. Antivirus service 202 may utilize antivirus signatures 112 to determine what requests to send, and what replies to expect in return. For example, antivirus service 202 may send a read request to stack 206, seeking a read of file 216, where file 216 is located within a virtual segment of memory. In such an example, antivirus service 202 may expect a certain value to be returned from reading file 216. The value may be predetermined, known by antivirus service 202, and accessible only by a properly functioning antivirus filter driver. If antivirus filter driver 210 has been modified, hacked, removed, or otherwise compromised, then antivirus filter driver 202 may receive a different result from a request to read file 216 than what was expected. In such a case, it may be determined that antivirus filter driver 210 has been modified, hacked, removed, or otherwise compromised.

In another example, antivirus service 202 may send a write or read request to stack 206, seeking access to file 216, where file 216 is located within a virtual segment of memory. File 216 may include a file name unrecognizable by, or illegal for file system 212. The file name may correspond to a naming scheme particular to the antivirus application 102. Antivirus filter driver 210, if resident and operating correctly, may receive such a request and be able to process the request by accessing log 214 and file 216, and send a reply back to antivirus service 202, without handing the request to file system driver 208. If antivirus filter driver 210 has been modified, hacked, removed, or otherwise compromised, then antivirus filter driver 202 may receive a different result than what was expected, such as an error generated by file system driver 208, from a request to read file 216. The request may have reached file system driver 208, which may have generated an error in response to the request.

Upon receipt of information that indicates that antivirus filter driver 210 has been modified, hacked, removed, or otherwise compromised, antivirus service 202 may notify antivirus engine 110 or antivirus application 102. Any combination of antivirus service 202, antivirus engine 110 or antivirus application 102 may take corrective action for antivirus filter driver 210. Antivirus filter driver 210 may be reinstalled. Information about the installation of antivirus filter driver 210 may be gathered for further analysis. Users or administrators of antivirus application 102 or electronic device 104 may be notified of the status of the antivirus filter driver 210. Additional corrective action may be taken for other portions of electronic device 104 related to the malware infection detected by the modifications in stack 206.

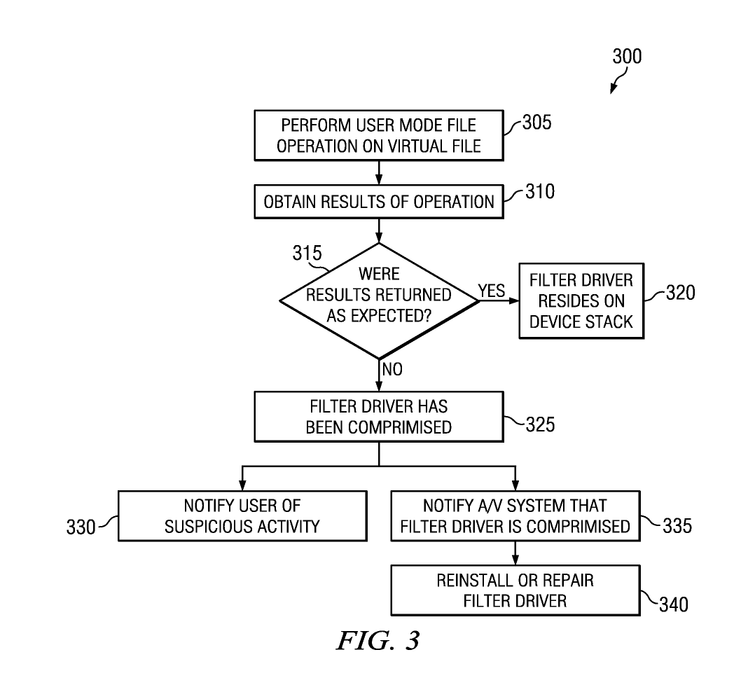

FIG. 3 is an example embodiment of a method 300 to detect malware that remove antivirus file system filter drivers from a device stack. In step 305, a user mode file operation may be performed on a virtual file. The virtual file may be accessible within the kernel mode of the operating system of an electronic device, such as through a device stack. The virtual file may be accessible by the presence of an antivirus file system filter driver within the device stack. In one embodiment, the user mode file operation may include a read request. In another embodiment, the user mode file operation may include a write request. The choice of what file operation to be conducted may be selected from a series of antivirus signatures, which indicate for a given operation, an expected result. In step 310, the result of the of the operation in the kernel mode may be obtained.

In step 315, it may be determined whether the result obtained from the operation was as expected. For example, a read operation for the virtual file may normally return a particular value. If the particular value was not returned, then the result obtained from the operation differed from what was expected. If the particular value was returned, then the result obtained from the operation was as expected. In such an example, the presence of an antivirus file system driver in the device stack may intercept the operation and correctly handle the read request, and return the correct value.

In another example, a write or read operation for the virtual file may include a parameter that may ordinarily, if not for the presence of an antivirus file system filter driver in the device stack, be an unrecognizable or illegal parameter. In one embodiment, such a parameter may comprise an unrecognizable or illegal file name for a file system for which device stack provides access. In such an example, the presence of an antivirus file system filter driver may intercept the request and handle the operation that would otherwise cause the device stack to generate an error. If an error is returned as a result of the operation, or if a value is returned that does not match a particular, expected value, then the result obtained from the operation differed from what was expected.

In step 320, if the result obtained from the operation was as expected, it may be determined that an antivirus file system filter driver resides on the device stack and is functioning normally.

In step 325, if the result obtained from the operation was different than what was expected, it may be determined that an antivirus file system filter driver that was supposed to be operating on the device stack has been modified, hacked, removed, or otherwise compromised. Corrective actions may be subsequently taken.

In step 330, a user or administrator may be notified that suspicious activity has taken place, and in particular an antivirus file system filter driver has been modified, hacked, removed, or otherwise compromised.

In step 335, an antivirus system may be notified that an antivirus file system filter driver has been modified, hacked, removed, or otherwise compromised. Additional information regarding device stack or filter driver may be provided. In step 340, the filter driver may be repaired or reinstalled.

Method 300 may be implemented using the system of FIGS. 1-2, or any other system operable to implement method 300. As such, the preferred initialization point for method 300 and the order of the steps comprising method 300 may depend on the implementation chosen. In some embodiments, some steps may be optionally omitted, repeated, or combined. In certain embodiments, method 300 may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other tangible, non-transitory media; and/or any combination of the foregoing.

Although the present disclosure has been described in detail, it should be understood that various changes, substitutions, and alterations can be made hereto without departing from the spirit and the scope of the disclosure as defined by the appended claims.

What is claimed is:

1. A method for detecting removal of a filter driver, comprising:
performing an operation on an element of a kernel mode of an operating system, the operation initiated by a user mode entity;
obtaining the result of performing the operation;
comparing the result of performing the operation against an expected result of the operation;
if the result of performing the operation matches the expected result of the operation, determining that a file system filter driver in the kernel mode of the operating system is working correctly;
if the result of performing the operation does not match the expected result of the operation, determining that a file system filter driver in the kernel mode of the operating system has been compromised by malware.

2. The method of claim 1, further comprising:
if the file system filter driver has been compromised by malware, notifying a user that the file system filter driver has been compromised by malware.

3. The method of claim 1, further comprising:
if the file system filter driver has been compromised by malware, notifying an antivirus application that the file system filter driver has been compromised by malware.

4. The method of claim 3, further comprising reinstalling at least a portion of the file system filter driver.

5. The method of claim 1, wherein the element of the kernel mode of an operating system comprises a device stack.

6. The method of claim 5, wherein the element of the kernel mode of the operating system comprises a virtual file.

7. The method of claim 1, wherein:
the element of the kernel mode of the operating system comprises a file;
the operation references a file name for the file;
the kernel mode of the operating system is configured to provide access to a file system;
the file system is configured to not allow operations on files having file name; and
the file system is configured to return an error as the result of performing the operation on the file, the error not matching the expected result of the operation.

8. An article of manufacture, comprising:
a computer readable medium; and
computer-executable instructions carried on the computer readable medium, the instructions readable by a processor, the instructions, when read and executed, for causing the processor to:
perform an operation on an element of a kernel mode of an operating system, the operation initiated by a user mode entity;
obtain the result of performing the operation;
compare the result of performing the operation against an expected result of the operation;
if the result of performing the operation matches the expected result of the operation, determine that a file system filter driver in the kernel mode of the operating system is working correctly;
if the result of performing the operation does not match the expected result of the operation, determine that a file system filter driver in the kernel mode of the operating system has been compromised by malware.

9. The article of claim 8, wherein the processor is further caused to:
if the file system filter driver has been compromised by malware, notify a user that the file system filter driver has been compromised by malware.

10. The article of claim 8, wherein the processor is further caused to:
if the file system filter driver has been compromised by malware, notify an antivirus application that the file system filter driver has been compromised by malware.

11. The article of claim 10, wherein the processor is further caused to reinstall at least a portion of the file system filter driver.

12. The article of claim 8, wherein the element of the kernel mode of an operating system comprises a device stack.

13. The article of claim 12, wherein the element of the kernel mode of the operating system comprises a virtual file.

14. The article of claim 8, wherein:
the element of the kernel mode of the operating system comprises a file;
the operation references a file name for the file;
the kernel mode of the operating system is configured to provide access to a file system;
the file system is configured to not allow operations on files having file name; and
the file system is configured to return an error as the result of performing the operation on the file, the error not matching the expected result of the operation.

15. A system for detecting malware, comprising:
a processor;
a computer readable medium; and
computer-executable instructions carried on the computer readable medium, the instructions readable by a processor, the instructions, when read and executed, for causing the processor to:
perform an operation on an element of a kernel mode of an operating system, the operation initiated by a user mode entity;
obtain the result of performing the operation;
compare the result of performing the operation against an expected result of the operation;
if the result of performing the operation matches the expected result of the operation, determine that a file system filter driver in the kernel mode of the operating system is working correctly;
if the result of performing the operation does not match the expected result of the operation, determine that a file system filter driver in the kernel mode of the operating system has been compromised by malware.

16. The system of claim 15, wherein the processor is further caused to:
if the file system filter driver has been compromised by malware, notify a user that the file system filter driver has been compromised by malware.

17. The system of claim 15, wherein the processor is further caused to:
if the file system filter driver has been compromised by malware, notify an antivirus application that the file system filter driver has been compromised by malware.

18. The system of claim 17, wherein the processor is further caused to reinstall at least a portion of the file system filter driver.

19. The system of claim 15, wherein the element of the kernel mode of an operating system comprises a device stack.

20. The system of claim 19, wherein the element of the kernel mode of the operating system comprises a virtual file.

21. The system of claim 19, wherein:
the element of the kernel mode of the operating system comprises a file;
the operation references a file name for the file;
the kernel mode of the operating system is configured to provide access to a file system;
the file system is configured to not allow operations on files having file name; and
the file system is configured to return an error as the result of performing the operation on the file, the error not matching the expected result of the operation.
